(19) United States
(12) Patent Application Publication
(10) Pub. No.: US 2026/0163406 A1
(43) Pub. Date: Jun. 11, 2026

(54) WIRELESS CHARGING SYSTEM

(71) Applicants: The Hong Kong Polytechnic University, Hong Kong (CN); MTR Corporation Limited, Hong Kong (CN)

(72) Inventors: Ka Wai Eric Cheng, Hong Kong (CN); Ka Wing Chan, Hong Kong (CN); Heshou Wang, Hong Kong (CN); William Ka Fai Lee, Hong Kong (CN); Ka Pui Lee, Hong Kong (CN); Xiaoxi Xu, Hong Kong (CN); Man Kit Mak, Hong Kong (CN)

(73) Assignees: The Hong Kong Polytechnic University, Hong Kong (CN); MTR Corporation Limited, Hong Kong (CN)

(21) Appl. No.: 19/242,252

(22) Filed: Jun. 18, 2025

Related U.S. Application Data
(60) Provisional application No. 63/728,414, filed on Dec. 5, 2024.

(51) Int. Cl. H02J 50/00; A61G 5/04; A61G 5/10; B60L 53/122; B60L 53/22; B60L 53/30; B61K 13/00; H01F 38/14; H02J 50/12

(52) U.S. Cl. CPC H02J 50/005; A61G 5/04; A61G 5/10; B60L 53/122; B60L 53/22; B60L 53/30; B61K 13/00; H01F 38/14; H02J 50/12; B60L 2200/24; B60L 2210/12

(57) ABSTRACT

Disclosed in the present application is a wireless charging system including a wireless charger and a wireless charging remote device. The wireless charger includes: a transmitter coil, configured to transferring power wirelessly, and comprising a plurality of windings wounded in spiral shape, wherein at least one turn of the plurality of windings comprises at least one bending part to form an accommodating space; a power converting circuit, configured to provide power to the transmitter coil; and at least one mechanical support, disposed in the accommodating space and is configured to withstand significant mechanical loads.

### CROSS REFERENCE

The present application claims priority to U.S. provisional application No. 63/728,414, filed on Dec. 5, 2024, the entire contents of which are incorporated herein by reference.

### TECHNICAL FIELD

The present disclosure relates to a wireless charging system, and in particular relates to a holistic design considering mechanical support and electrical parameters for a wireless charging system.

### BACKGROUND

Wireless power transfer (WPT) has become a crucial technology in modern charging systems. With the continuous advancement of charging power levels, WPT offers significant advantages for a variety of electrical devices by eliminating the need for cables. A notable application of WPT is in the realm of electric vehicles, where magnetic coupling coils can be installed on surface of the ground. This installation method is particularly advantageous in densely populated areas, as it integrates seamlessly with parking lots.

It should be noted that, information disclosed in the above background portion is provided only for better understanding of the background of the present disclosure, and thus it may contain information that does not form the prior art known by those ordinary skilled in the art.

### SUMMARY

The present disclosure provides a wireless charger, a wireless charging remote device, and a method for charging the wireless charging remote device using the wireless charger.

A first aspect of the present disclosure relates to a wireless charger, including:
a transmitter coil, configured to transferring power wirelessly, and including a plurality of windings wounded in spiral shape, wherein at least one turn of the plurality of windings includes at least one bending part to form an accommodating space;
a power converting circuit, configured to provide power to the transmitter coil; and
at least one mechanical support, disposed in the accommodating space and is configured to withstand significant mechanical loads.

According to an implementation of the present disclosure, each turn of the plurality of windings are wounded in at least one of: a circular shape, or a polygon shape.

According to an implementation of the present disclosure, the at least one bending part is disposed at any one of a second innermost turn to an outermost turn of the transmitter coil, and the bending part is bent in a direction away from a turn inner to the at least one turn of the plurality of windings.

According to an implementation of the present disclosure, in a case where the windings are in the circular shape, the at least one turn of the plurality of windings includes a plurality of bending parts disposed at even intervals along the circular shape; and
in a case where the windings are in the polygon shape, the at least one turn of the plurality of windings includes a bending part disposed on each side of the polygon shape.

According to an implementation of the present disclosure, in a case where the windings are in a rectangular shape, the accommodating space is further formed at each corner of the rectangular shape.

According to an implementation of the present disclosure, each turn of the plurality of windings are configured to have a same turn-pitch except at the bending part where the turn-pitch is decreased.

According to an implementation of the present disclosure, the mechanical support is formed of a non-conductor and non-magnetic material.

According to an implementation of the present disclosure, the power converting circuit includes an LCC-S compensation network, configured to maintain a constant voltage output across a wide range of load conditions.

According to an implementation of the present disclosure, wherein the power converting circuit includes a buck converter, configured to mitigate voltage spikes and maintain stable voltage under open-circuit or high-load conditions.

According to an implementation of the present disclosure, the wireless charger is embedded under a surface of floor, or surface-mounted on the surface of floor.

According to an implementation of the present disclosure, the wireless charger is configured to be mounded in a public transportation station or inside a train.

A second aspect of the present disclosure relates to a wireless charging remote device, including:
a body;
a receiver coil, disposed at a lower side of the body, is configured to receive power wirelessly, and including a plurality of windings wounded in spiral shape, wherein at least one turn of the plurality of windings includes at least one bending part to form an accommodating space;
a power converting circuit, configured to covert the power received from the receiver coil to a battery management system of the wireless charging remote device; and
at least one mechanical connector, disposed in the accommodating space and is configured to connect the receiver coil to the body.

According to an implementation of the present disclosure, each turn of the plurality of windings are wounded in at least one of: a circular shape, or a polygon shape.

According to an implementation of the present disclosure, the at least one bending part is disposed at any one of a second innermost turn to an outermost turn of the transmitter coil, and the bending part is bent in a direction away from a turn inner to the at least one turn of the plurality of windings.

According to an implementation of the present disclosure, in a case where the windings are in the circular shape, the at least one turn of the plurality of windings includes a plurality of bending parts disposed at even intervals along the circular shape; and

in a case where the windings are in the polygon shape, the at least one turn of the plurality of windings includes a bending part disposed on each side of the polygon shape.

According to an implementation of the present disclosure, in a case where the windings are in the rectangular shape, the accommodating space is further formed at each corner of the rectangular shape.

According to an implementation of the present disclosure, each turn of the plurality of windings are configured to have a same turn-pitch except at the bending part where the turn-pitch is decreased.

According to an implementation of the present disclosure, the power converting circuit includes a closed-loop system including sensors and controllers configured to maintain a constant voltage range and ensure stable operation across a broad spectrum of load conditions.

A third aspect of the present disclosure relates to a method for charging wirelessly charging a wireless charging remote device using the wireless charger according to claim 1, including:
positioning the wireless charging remote device over the transmitter coil of the wireless charger; and
activating the power converting circuit of the wireless charger and a power converting circuit of the wireless charging remote device to initiate power transfer; and
monitoring and adjusting the power transfer using the power converting circuit of the wireless charger and the power converting circuit of the wireless charging remote device.

According to an implementation of the present disclosure, the method further includes conducting periodic stress and thermal management analyses to ensure integrity of the mechanical support and effective heat dissipation.

It is to be understood that both the foregoing general description and the following detailed description are exemplary and explanatory only and are not restrictive of the present disclosure.

### BRIEF DESCRIPTION OF THE DRAWINGS

The appended drawings provide figures that further illustrate and clarify the aforementioned and additional aspects, advantages, and features of the present disclosure. It is understood that these drawings represent only specific embodiments of the present disclosure and are not intended to limit its scope. Additionally, these drawings are presented for simplicity and clarity and may not be depicted to scale. The present disclosure will now be described and explained in greater specificity and detail using the accompanying drawings, in which:

FIG. 1 illustrates a wireless power transfer system including a Transmitter (L_{P}) and a Receiver (L_{S}) according to an embodiment of the present disclosure;

FIG. 2 illustrates a detailed circuit schematic for the wireless power transfer system with series-series (S-S) compensation network of FIG. 1;

FIG. 3 illustrates a detailed circuit schematic for the wireless power transfer system with an inductor-capacitor-capacitor-series (LCC-S) compensation network according to an embodiment of the present disclosure;

FIG. 4 illustrates a wireless charging system with a circular N induction coil structure for both Transmitter and Receiver according to an embodiment of the present disclosure;

FIG. 5 illustrates a wireless charging system with a rectangular N induction coil structure for both Transmitter and Receiver according to an embodiment of the present disclosure;

FIG. 6 illustrates a wireless charging system with a hexagonal N induction coil structure for both Transmitter and Receiver according to an embodiment of the present disclosure;

FIG. 7 illustrates a schematic block diagram of a wireless charging system according to an embodiment of the present disclosure;

FIG. 8 illustrates a schematic diagram of a wireless charging system according to an embodiment of the present disclosure;

FIG. 9 illustrates a schematic diagram of a wireless charger surface-mounted on the ground; and

FIG. 10 illustrates a schematic block diagram of the wireless charging system including chargers deployed at different locations according to an embodiment of the present disclosure.

### DETAILED DESCRIPTION

The following detailed description is provided merely as an exemplary embodiment and is not intended to limit the scope of the disclosure or its applications and uses. It should be understood that numerous variations are possible. This detailed description will enable those skilled in the art to implement an exemplary embodiment of the present disclosure without undue experimentation. It is further understood that various changes or modifications in function and structure described in the exemplary embodiment may be made without departing from the scope of the present disclosure as defined in the appended claims.

The benefits, advantages, solutions to problems, and any element(s) that may provide or enhance these benefits, advantages, or solutions should not be interpreted as critical, required, or essential features or elements of any or all of the claims. The invention is defined solely by the appended claims, including any amendments made during the pendency of this application and all equivalents of those claims as issued.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” and “including” or any other variation thereof, are to be construed as open-ended terms (i.e., meaning “including, but not limited to,”) unless otherwise noted. The use of any and all examples, or exemplary language (e.g., “such as”) provided herein, is intended merely to illuminate the invention better and does not pose a limitation on the scope of the invention unless otherwise claimed. No language in the specification should be construed as indicating any non-claimed element as essential to the practice of the invention. Further, unless expressly stated to the contrary, “or” refers to an inclusive “or” and not to an exclusive “or”. For example, a condition A or B is satisfied by any one of the following: A is true and B is false, A is false and B is true, and both A and B are true. Terms of approximation, such as “about”, “generally”, “approximately”, and “substantially” include values within ten percent greater or less than the stated value.

Unless otherwise defined, all terms (including technical and scientific terms) used in the embodiments of the present invention shall have the same meaning as commonly understood by a person of ordinary skill in the relevant art.

As used herein, the terms “transmitter,” “receiver,” “primary,” and “secondary” refer to the transmission of electrical energy from a transmitting device to a receiving device. However, it should be noted that energy transmission may occasionally occur in the opposite direction. For example, a small amount of energy may be transmitted in reverse to enhance the alignment of the transmitter and receiver or to achieve other communication purposes. In such instances, the “transmitter” may be configured to receive energy, and the “receiver” may be configured to transmit energy.

The term “wirelessly charging” or similar expressions refer to the transfer of any form of energy associated with electric fields, magnetic fields, electromagnetic fields, or other mechanisms from a transmitter to a receiver without the use of physical electrical conductors. The power output into a wireless field (e.g., a magnetic field) may be received, captured, or coupled by an induction coil at the receiver to facilitate power transfer. It is understood that the term “coupled” may refer to interaction through direct or indirect means, and may denote either a physically connected (e.g., wired) coupling or a physically disconnected (e.g., wireless) coupling.

The described structure can have any suitable components or characteristics that allow the structure to perform wireless charging with the consideration of the mechanical support for an electric wheelchair. In order to achieve the objective, special magnetic coils are designed to provide enough mechanical support and electrical magnetic coupling for the electric wheelchairs. In the preferred application, the structure is used for charging an electric wheelchair. In other alternative embodiments, the structure can have any suitable designs that allow the structure to be used for charging other battery packs in other electrically powered devices with the requirement of the enough mechanical support, such as electric vehicles, and automatic guided vehicles, and the like.

Among the various types of electric vehicles, electric wheelchairs particularly benefit from wireless charging technology. Wireless power transfer (WPT) offers significant potential for charging electric wheelchairs due to the unique needs of their users. Many electric wheelchair users face challenges in manually connecting a charger, such as reaching for a charger, managing a cable, or handling the weight of conventional charging equipment. These tasks can be especially difficult for users with limited hand mobility or strength.

Consequently, a significant number of electric wheelchair users require caregiver assistance to plug in a charger. Implementing a wireless charging system for electric wheelchairs would provide a more convenient and accessible solution. This technology would not only improve personal mobility by offering a long-lasting energy source but also reduce the need for caregiver assistance, thus promoting greater independence for users and facilitating more autonomous outdoor travel.

However, the mechanical support for such systems is often inadequately designed. Conventional approaches typically involve enclosing the magnetic coupling coil within a box-like structure. While this method suffices for lightweight devices such as smartphones and laptops, it is unsuitable for heavier electric vehicles, including electric wheelchairs. Misalignment issues and the inability to handle significant mechanical loads become apparent under these conditions. Thus, there is a critical need for a robust mechanical support system tailored specifically for the wireless charging of heavy electric wheelchairs.

Embodiments of the present disclosure proposes a novel holistic design approach that integrates mechanical support with electrical parameters for wireless power transfer systems, particularly targeting the charging of electric wheelchairs.

Furthermore, special consideration is given to mechanical stress and inadvertent contact issues. The traditional support mechanisms are inadequate for these scenarios, necessitating a thin and robust mechanical structure.

This invention addresses these challenges by introducing a specialized magnetic coil design to leave the space for the mechanical support system that not only protects the magnetic coupling structure but also ensures the durability and performance of the wireless charging process.

The design incorporates an integrated mechanical and coil structure, optimizing the overall system for high-performance wireless charging. This new system is ideal for environments requiring the addition of wireless chargers, such as subway stations and train interiors.

Particularly, the present disclosure is related to systems and methods with special design in mechanical support and coil structures for transferring power wirelessly to an electric wheelchair either in the subway station or inside the train. In other words, this invention pertains to the field of wireless power transfer systems, particularly focusing on the design of mechanical support and electrical parameters. The primary application of this invention is in the charging of electric wheelchairs, a critical area to support people in need. This technology aims to provide efficient, reliable, and convenient wireless charging solutions for electric wheelchairs.

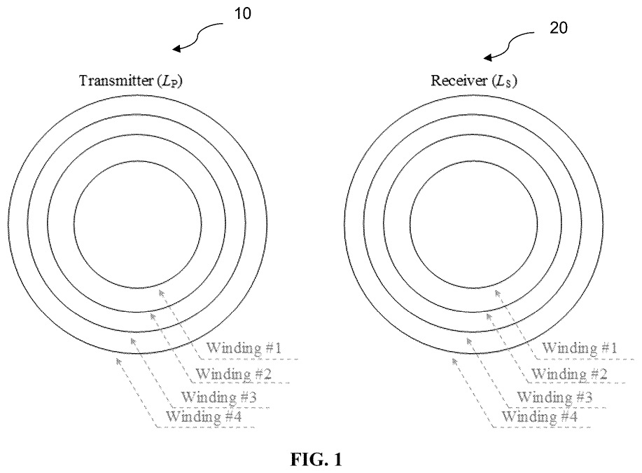

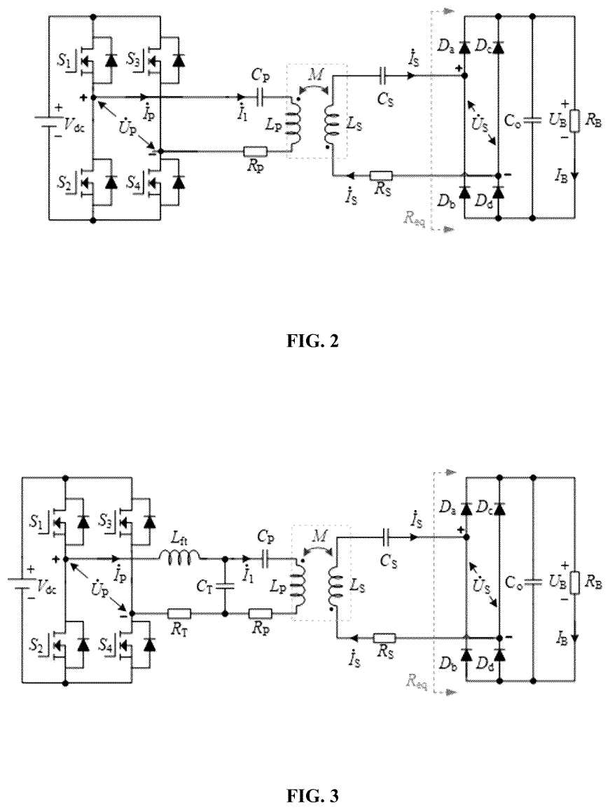

FIG. 1 illustrates a wireless power transfer system including a Transmitter (L_{P}) and a Receiver (L_{S}) according to an embodiment of the present disclosure; and FIG. 2 illustrates a detailed circuit schematic for the wireless power transfer system with series-series (S-S) compensation network of FIG. 1.

As shown in FIG. 1, the wireless power transfer system includes a Transmitter (L_{P}) and a Receiver (L_{S}). The transmitter (L_{P}) may be included in a wireless charger, that performs wireless power transmission between the wireless charger and the charging object including the Receiver (L_{S}). Each of the Transmitter (L_{P}) and the Receiver (L_{S}) includes a coil including a plurality of windings wounded in spiral shape. In the drawings, four turns of winding are shown in each coil, indicated by Winding #1 to Winding #4 respectively. It should be noted that the number of turns of the winding is not limited in the present disclosure.

As shown in FIG. 1 and FIG. 2, the Transmitter (L_{P}) is configured to transmit wireless power, and the Receiver (L_{S}) is configured to receive the wireless power. In particular, the Transmitter (L_{P}) receives power from a power converting circuit and transmits the power wirelessly to the Receiver (L_{S}) by the mutual inductance between the Transmitter (L_{P}) and the Receiver (L_{S}). The Receiver (L_{S}) may transmit the received power to a power converting circuit to charge a battery through a battery management system (BMS).

In further detail, the power converting circuit of the charger converts the power of external power source Vdc to the primary power Up, and supplies the primary power Up to the transmitter (L_{P}). The primary power Up is then transmitted to the Receiver (L_{S}) by the mutual inductance between the Transmitter (L_{P}) and the Receiver (L_{S}), and the received secondary power Us is then supplied to the power converting circuit of the receiver, and then is converted into required voltage Ub to charge the battery through the battery management system (BMS).

Further, as shown in FIG. 2, the present embodiment includes a series-series (S-S) compensation network, in which the transmitter side includes the primary capacitor Cp and the primary inductor Lp connected in serial, and the receiver side includes the secondary capacitor Cs and the secondary inductor Ls connected in serial.

FIG. 3 illustrates a detailed circuit schematic for the wireless power transfer system with an inductor-capacitor-capacitor-series (LCC-S) compensation network according to an embodiment of the present disclosure.

As shown in FIG. 3, the present embodiment includes an inductor-capacitor-capacitor-series (LCC-S) compensation network, to maintain a constant voltage output across a wide range of load conditions. In the LCC-S compensation network, the transmitter side includes a filter inductor Lft connected to the primary capacitor Cp and the primary inductor Lp in serial, and includes a capacitor C_{T} connected between the filter inductor Lft and the primary inductor Lp in parallel. Also, the receiver side includes the secondary capacitor Cs and the secondary inductor Ls connected in serial.

The inductor-capacitor-series-series (LCC-S) compensating topology is employed to achieve a relatively constant voltage (CV) output. This network significantly reduces the complexity in the design of the battery management systems (BMS) by maintaining a stable input voltage, which is essential for efficient battery charging and load management. The compensation network is designed to handle a wide range of load variations, ensuring stable operation under different charging conditions.

FIG. 3 shows the detailed circuit schematic. Since most of the higher-order harmonics are trapped in the resonant circuit, only the fundamental component is considered in this article to simplify the analysis.

$${\dot{U}}_{P} = \frac{2 \sqrt{2} {V}_{dc}}{π} ∠0° \qquad ( 1 )$$

wherein:
V_{dc} is the DC input voltage of the H-bridge inverter at the primary side (base device, e.g., the wireless charger);
U_{P} is the AC output voltage of the H-bridge inverter at the primary side (base device);

After the LCC-S compensation network and neglecting the parasitic resistances R_{T}, R_{P}, and R_{S}, the output voltage on the battery at the remote device can be expressed as

$${U}_{B} = \frac{M}{{L}_{ft}} {V}_{dc} \qquad ( 2 )$$

wherein:
U_{B} is the output voltage on the battery at the secondary side (remote device, e.g., an electric wheelchair);
R_{T} is the parasitic resistance of the compensation inductor (Lft) at the primary side (base device);
R_{P} is the parasitic resistance of the transmitter coil (LP) at the primary side (base device);
R_{S} is the parasitic resistance of the receiver coil (LP) at the secondary side (remote device);

The LCC-S compensation network is analyzed in detail, highlighting its role in maintaining constant voltage output. The design considerations for the compensation network are discussed, including the selection of inductance and capacitance values to achieve optimal performance.

Furthermore, a closed-loop system is integrated into the load side to regulate output voltage. The closed-loop system on the load side includes sensors and controllers to maintain a constant voltage range of 12-24V, or 24-50V, ensuring stable operation across a broad spectrum of load conditions. The design and testing of the closed-loop system are described, demonstrating its effectiveness in maintaining voltage stability across a wide range of load conditions.

As shown in FIG. 3, the output power of the receiver, i.e., the voltage Us, is input to a rectifier to convert the voltage Us into a DC voltage suitable for charging the battery. And the output of the rectifier is connected to a buck converter configured to mitigate voltage spikes and maintain stable voltage under open-circuit or high-load conditions. In the embodiment, the buck converter is designed to regulate output voltage by adjusting to varying load conditions without requiring communication between the transmitting and receiving sides, ensuring reliable operation.

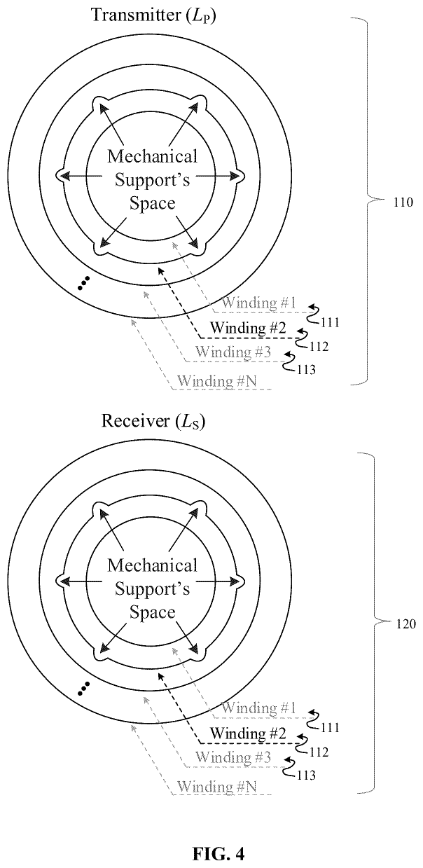

FIG. 4 illustrates a wireless charging system with a circular N induction coil structure for both Transmitter and Receiver according to an embodiment of the present disclosure. As shown in FIG. 4, one embodiment of the present disclosure provides a first wireless charging system 100 with a circular N induction coil structure. In particular, the first wireless charging system 110 includes a circular transmitter coil with the mechanical support's space to sustain enough stress from an electric wheelchair; and a circular receiver 120 having the mechanical support's space for connecting the receiving coils to the remote device such as an electric wheelchair.

In particular, referring to FIG. 4, the wireless charging system includes a wireless charger including a transmitter coil, i.e., the Transmitter (Lp). The transmitter coil is configured to transferring power wirelessly, and includes a plurality of windings wounded in spiral shape, wherein at least one turn of the plurality of windings comprises at least one bending part to form an accommodating space. As shown in FIG. 4, the transmitter coil includes N turns of winding, and the second innermost winding (the Winding #2) are formed with six bending parts, and correspondingly, six accommodating spaces are formed by the six bending parts. The accommodating space may be used as the mechanical support's space to sustain enough stress from an electric wheelchair. In this way, the wireless charger may include at least one mechanical support, disposed in the accommodating space and is configured to withstand significant mechanical loads.

As shown in FIG. 4, the Receiver (Ls) may have substantially the same coil structure as that of the Transmitter. That is, the Receiver (Ls) may have a receiver coil configured to receiving power wirelessly, and includes a plurality of windings wounded in spiral shape, wherein at least one turn of the plurality of windings comprises at least one bending part to form an accommodating space. As shown in FIG. 4, the receiver coil includes N turns of winding, and the second innermost winding (the Winding #2) are formed with six bending parts, and correspondingly, six accommodating spaces are formed by the six bending parts. The accommodating space may be used as the mechanical support's space to sustain external stress. Also, the accommodating space may be used for accommodating the mechanical connector for connecting the receiver coil to the body of the remote device (e.g., the electrical wheelchair). The receiver coil and the bending parts of the receiver coil may have the same structure as that of the transmitter coil, and thus detailed description thereof will be omitted.

Moreover, the wireless charger may include the power converting circuit discussed above with reference to FIG. 2 and FIG. 3, and the description thereof will not be repeated herein.

As shown in FIG. 4, bending parts are formed on the second innermost winding (the Winding #2), while it should be noted that the present disclosure is not limited thereto. According to an implementation of the present disclosure, the at least one bending part is disposed at any one of a second innermost turn to an outermost turn of the transmitter coil, and the bending part is bent in a direction away from a turn inner to the at least one turn of the plurality of windings. That is, the bending part is formed on any turn of the turns except the innermost turn.

In the embodiment, six bending parts are included in one turn, while the present disclosure is not limited thereto, the bending parts may have different numbers, and may be formed on different turns. Also, in the case that one turn has multiple bending parts, the bending parts may be disposed at even intervals along the turn. As shown in FIG. 4, the six bending parts are disposed at even intervals along the circular shaped turn.

As shown in FIG. 4, each turn of the plurality of windings are configured to have a same turn-pitch except at the bending part where the turn-pitch is decreased. That is, at the position where the bending part is disposed, the turn-pitch of the windings may be decreased, also, the adjacent winding's turn pitch may also be decreased and may vary in order to fit the geometry of the mechanical support.

In the present disclosure, the mechanical support is formed of a non-conductor and non-magnetic material. The mechanical support may be formed as a pillar that withstands external mechanical loads. For example, the mechanical support may be a plastic pillar formed in the accommodating space. The plastic pillar may be distributed uniformly in the transmitter coil, to withstand external mechanical loads.

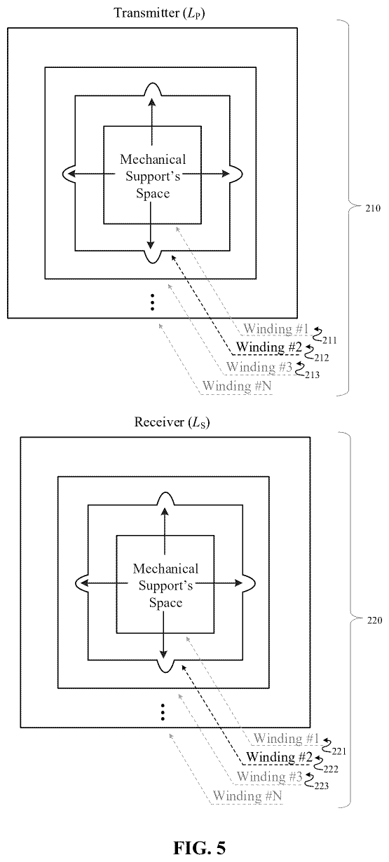

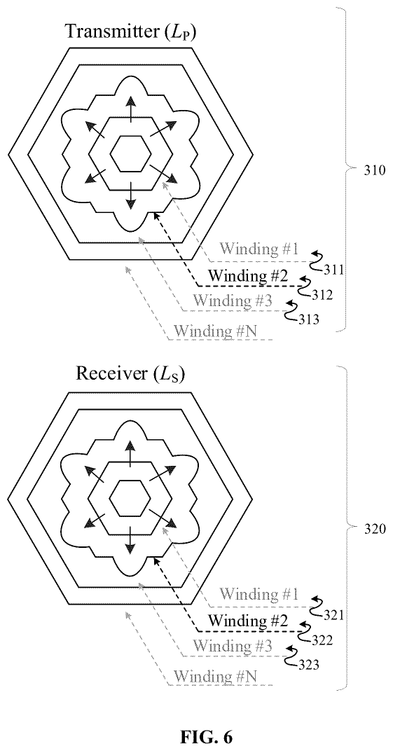

Each turn of winding in the transmitter coil may be circular in shape, while the present disclosure is not limited thereto. In some other embodiments, the turn of winding in the transmitter coil may also have other shapes. For example, the winding may have a polygon shape, such as a triangle, a rectangular, a pentagon, a hexagon, or the like. FIG. 5 illustrates a wireless charging system with a rectangular N induction coil structure for both Transmitter and Receiver according to an embodiment of the present disclosure; and FIG. 6 illustrates a wireless charging system with a hexagonal N induction coil structure for both Transmitter and Receiver according to an embodiment of the present disclosure.

As shown in FIG. 5 and FIG. 6, in the embodiment of the present disclosure, the polygon windings may have a regular polygon shape, and the bending parts are disposed on each side of the polygon shape. For example, the bending part is disposed on a center of each side of the polygon shape, so that the bending parts are evenly distributed along the winding.

In further detail, as shown in FIG. 5, another embodiment of the present disclosure provides a second wireless charging system 200 with a rectangular N induction coil structure. In particular, the second wireless charging system 210 includes a rectangular transmitter coil with the mechanical support's space to sustain enough stress from an electric wheelchair; and a rectangular receiver 120 having the mechanical support's space for connecting the receiving coils to the remote device such as an electric wheelchair.

Further, as shown in FIG. 6, another embodiment of the present disclosure provides a third wireless charging system 300 with a hexagonal N induction coil structure. In particular, the third wireless charging system 310 includes a hexagonal transmitter coil with the mechanical support's space to sustain enough stress from an electric wheelchair; and a hexagonal receiver 320 having the mechanical support's space for connecting the receiving coils to the remote device such as an electric wheelchair, as demonstrated in FIG. 6.

In another example, in the case where the windings are in a rectangular shape, the accommodating space is further formed at each corner of the rectangular shape. That is, when the windings are in a rectangular shape, in addition to the four accommodating spaces formed on the four sides, another four accommodating spaces may be formed at the four corners. That is, in one turn of the windings, eight accommodating spaces may be provided. In this way, more mechanical support may be provided to withstand significant mechanical loads.

Also, according to the above embodiments, the receiver coil may have substantially the same structure as the transmitter coil, and thus detailed description will be omitted.

FIGS. 4-6 provide the three different shapes of the induction coils of both Tx and Rx. It is apparent that the shapes of the induction coils illustrated are simple exemplary designs and may be otherwise. For instance, the induction coils of the Transmitter and Receiver may have the shape of a square, a rhombus, a pentagon, a heptagon, an octagon, an oval, a star, or a clover, etc., without departing from the scope and spirit of the present disclosure.

In the above embodiments, the wireless charging system includes, corresponding to the wireless charger, a wireless charging remote device, which may be for example an electric wheelchair, and the wireless charging remote device may include: a body; a receiver coil, disposed at a lower side of the body, is configured to receive power wirelessly, and including a plurality of windings wounded in spiral shape, wherein at least one turn of the plurality of windings includes at least one bending part to form an accommodating space; a power converting circuit, configured to covert the power received from the receiver coil to a battery management system of the electric wheelchair; and at least one mechanical connector, disposed in the accommodating space and is configured to connect the receiver coil to the body.

The detailed description of the wireless charging remote device may refer to the corresponding description of the wireless charger above, which will not be repeated herein.

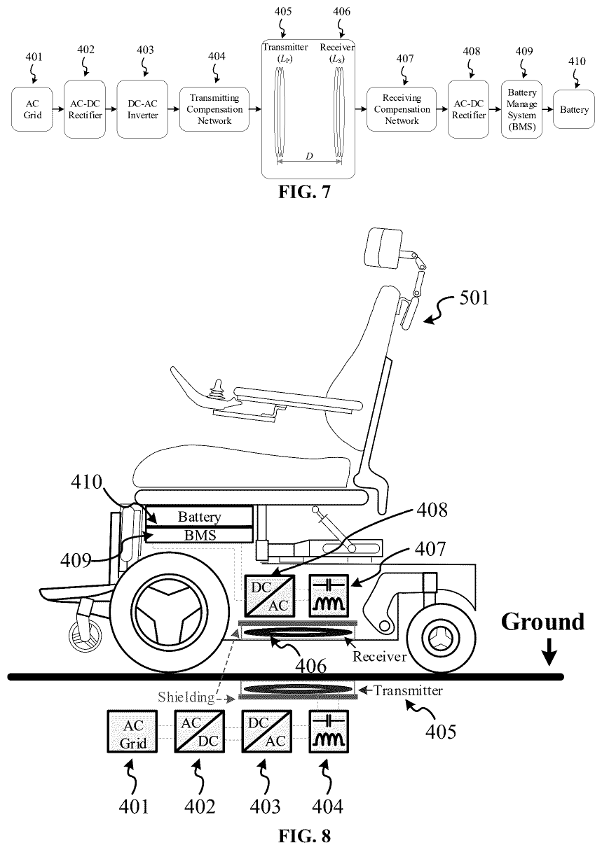

Hereinafter, the operation of the wireless charging system is explained with reference to FIG. 7. FIG. 7 illustrates a schematic block diagram of a wireless charging system according to an embodiment of the present disclosure.

As shown in FIG. 7, according to this embodiment, the wireless charging system may receive power from the commensal AC grid. Blok 401 of FIG. 7 schematically shows the AC grid, while it should be understood that the AC grid is not essentially a part of the wireless charging system.

The received AC power from the AC grid is provided to an AC-DC rectifier 402, and the AC power is converted by the rectifier 402 into DC power. The DC power may correspond to the power supply Vdc shown in FIG. 2 and FIG. 3, which will not be described in detail herein. Nevertheless, it should be understood that when DC power supply is used, the AC-DC rectifier 402 can be omitted.

Then, the DC power is provided to the DC-AC inverter 403, and the DC power is converted into AC power for transmission over the transmitter coil. The DC-AC Inverter 403 may include switches and bridge circuits like the switches S1 to S4 and the bridge circuit shown in FIG. 2 and FIG. 3, which will not be described in detail herein.

The AC power is then provided to a transmitting compensation network 404, which may include the S-S compensation network shown in FIG. 2, or the LCC-S compensation network shown in FIG. 3, and which will not be described in detail herein.

The compensated AC power is then provided to the transmitter coil 405 for wireless power transmission and then is received by the receiver coil 406. The detailed structure of the transmitter coil 405 and receiver coil 406 may refer to the embodiments above, which will not be repeated herein.

Further, the received AC power is provided to a receiving compensation network 407. The detail of the compensation network may refer to the S-S compensation network or the LCC-S compensation network shown in FIG. 2 and FIG. 3, which will not be repeated herein.

The compensated AC power is then provided to an AC-DC rectifier 408 and converted into DC power for DC charging of the battery. The AC-DC rectifier 408 may include diodes and bridge circuits like the diodes Da-Dd and the bridge circuit shown in FIG. 2 and FIG. 3, which will not be described in detail herein.

The DC power is then provided to a battery management system (BMS) 409, which manages the charging voltage and charging current to charge the battery 410. The BMS 409 may include the buck converter discussed in the above embodiment, which will not be described in detail herein.

Hereinafter, taking an electric wheelchair as an example, the wireless charging system and a method for charging is described with reference to FIG. 8. FIG. 8 illustrates a schematic diagram of a wireless charging system according to an embodiment of the present disclosure.

As shown in FIG. 8, the wireless charging remote device is an electric wheelchair, which includes a body 501 and each of the components 406-410 shown in FIG. 7, and the wireless charger includes each of the components 401-405 shown in FIG. 7. The similar reference numeral indicates the same or similar elements, and thus repeated description will be omitted.

When charging the electric wheelchair, the electric wheelchair is positioned over the transmitter coil 405 of the wireless charger. Then, the power converting circuit of the wireless charger and a power converting circuit of the electric wheelchair are activated to initiate power transfer. That is, the AC power from the AC grid 401 is converted, transmitted, and charged to the battery 410 of the electric wheelchair. The detailed process may refer to the above embodiment, and thus will not be repeated herein.

During the charging process, the method further includes monitoring and adjusting the power transfer using the power converting circuit of the wireless charger and the power converting circuit of the electric wheelchair.

Moreover, the method may further include conducting periodic stress and thermal management analyses to ensure integrity of the mechanical support and effective heat dissipation. That is, in the embodiment, the power converting circuit may include a closed-loop system including sensors and controllers configured to maintain a constant voltage range and ensure stable operation across a broad spectrum of load conditions.

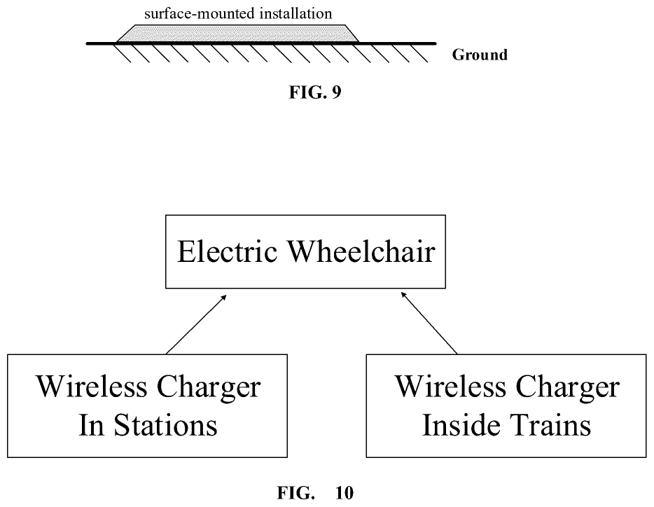

In the embodiment shown in FIG. 8, the wireless charger is embedded under the ground, e.g., a floor of the charging station, while the present disclosure is not limited thereto. According to the embodiment of the present disclosure, the wireless charger includes the mechanical support configured to withstand significant mechanical loads and therefore can be mounted on the ground. For example, as shown in FIG. 9, in the surface-mounted installation, the wireless charger is surface-surface-mounted on the surface of the ground, e.g., on the floor of the charging station. As the wireless charger can withstand significant mechanical loads, it will not be damaged by the heavier electric vehicles, such as the electric wheelchair.

In the present disclosure, a site where the wireless charger is mounted, regardless of surface-mounted or embedded-mounted, can be refereed to as a charging station. The wireless charging remote device, e.g., the electric wheelchair, can be driven to any charging station and be charged by the wireless charger mounted in the charging station.

In this way, a flexible charging method can be provided, as the charging station can be constructed at many sites where wireless charging may be required. For example, in a public transportation system such an urban rail transit system, the charging station can be constructed both in a station or inside a train.

For example, as shown in FIG. 10, the charging system includes an electric wheelchair as the wireless charging remote device, a wireless charger constructed in the stations, and a wireless charger constructed inside the trains. The electric wheelchair can be charged by both the two wireless chargers, and thus during the traveling of the electric wheelchair, flexible charging service of the electric wheelchair can be provided both when the user is waiting for the train in the station, or when the user is onboard of the train.

According to the embodiments of the present disclosure, a holistic design for electric wheelchair wireless charging systems, integrating mechanical support and optimized electrical parameters to address the specific needs of this application. Wireless power transfer (WPT) technology is increasingly important for charging systems, offering significant advantages by eliminating the need for cables. This is particularly beneficial for electric wheelchair users who may face difficulties in manually connecting chargers due to limited hand mobility. The invention features a robust mechanical support system tailored for electric wheelchairs, addressing issues such as efficiency, misalignments, and mechanical load handling. The mechanical design includes holistically integrated coils and space for mechanical supports such as plastic pillars, theoretical analysis and flexible installation methods for surface-mounted wireless charging setups.

The electrical parameters are optimized through an LCC-S compensation network, ensuring a relatively constant voltage output. Moreover, this system also includes a closed-loop system for voltage regulation, and a buck converter to manage voltage spikes under varying load conditions. This invention addresses a significant gap in wireless charging technology for electric wheelchairs, enhancing personal mobility, reducing caregiver involvement, and promoting greater independence for users. The integrated design not only improves performance but also ensures safety and durability for electric wheelchairs, making it suitable for being charged in a wider scenario, such as public transportation stations and the interior of trains.

Embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. A wireless charger, comprising:
a transmitter coil, configured to transferring power wirelessly, and comprising a plurality of windings wounded in spiral shape, wherein at least one turn of the plurality of windings comprises at least one bending part to form an accommodating space;
a power converting circuit, configured to provide power to the transmitter coil; and
at least one mechanical support, disposed in the accommodating space and is configured to withstand significant mechanical loads.

2. The wireless charger according to claim 1, wherein each turn of the plurality of windings are wounded in at least one of: a circular shape, or a polygon shape.

3. The wireless charger according to claim 2, wherein the at least one bending part is disposed at any one of a second innermost turn to an outermost turn of the transmitter coil, and the bending part is bent in a direction away from a turn inner to the at least one turn of the plurality of windings.

4. The wireless charger according to claim 3, wherein in a case where the windings are in the circular shape, the at least one turn of the plurality of windings comprises a plurality of bending parts disposed at even intervals along the circular shape; and
in a case where the windings are in the polygon shape, the at least one turn of the plurality of windings comprises a bending part disposed on each side of the polygon shape.

5. The wireless charger according to claim 4, wherein in a case where the windings are in a rectangular shape, the accommodating space is further formed at each corner of the rectangular shape.

6. The wireless charger according to claim 1, wherein each turn of the plurality of windings are configured to have a same turn-pitch except at the bending part where the turn-pitch is decreased.

7. The wireless charger according to claim 1, wherein the mechanical support is formed of a non-conductor and non-magnetic material.

8. The wireless charger according to claim 1, wherein the power converting circuit comprises an LCC-S compensation network, configured to maintain a constant voltage output across a wide range of load conditions.

9. The wireless charger according to claim 1, wherein the wireless charger is embedded under a surface of floor, or surface-mounted on the surface of floor.

10. The wireless charger according to claim 1, wherein the wireless charger is configured to be mounded in a public transportation station or inside a train.

11. An wireless charging remote device, comprising:
a body;
a receiver coil, disposed at a lower side of the body, is configured to receive power wirelessly, and comprising a plurality of windings wounded in spiral shape, wherein at least one turn of the plurality of windings comprises at least one bending part to form an accommodating space;
a power converting circuit, configured to covert the power received from the receiver coil to a battery management system of the wireless charging remote device; and
at least one mechanical connector, disposed in the accommodating space and is configured to connect the receiver coil to the body.

12. The wireless charging remote device according to claim 11, wherein each turn of the plurality of windings are wounded in at least one of: a circular shape, or a polygon shape.

13. The wireless charging remote device according to claim 12, wherein the at least one bending part is disposed at any one of a second innermost turn to an outermost turn of the transmitter coil, and the bending part is bent in a direction away from a turn inner to the at least one turn of the plurality of windings.

14. The wireless charging remote device according to claim 13, wherein in a case where the windings are in the circular shape, the at least one turn of the plurality of windings comprises a plurality of bending parts disposed at even intervals along the circular shape; and
in a case where the windings are in the polygon shape, the at least one turn of the plurality of windings comprises a bending part disposed on each side of the polygon shape.

15. The wireless charging remote device according to claim 14, wherein in a case where the windings are in the rectangular shape, the accommodating space is further formed at each corner of the rectangular shape.

16. The wireless charging remote device according to claim 11, wherein each turn of the plurality of windings are configured to have a same turn-pitch except at the bending part where the turn-pitch is decreased.

17. The wireless charging remote device according to claim 11, wherein the power converting circuit comprises a closed-loop system comprising sensors and controllers configured to maintain a constant voltage range and ensure stable operation across a broad spectrum of load conditions.

18. The wireless charger according to claim 11, wherein the power converting circuit comprises a buck converter, configured to mitigate voltage spikes and maintain stable voltage under open-circuit or high-load conditions.

19. A method for charging wirelessly charging a wireless charging remote device using the wireless charger according to claim 1, comprising:
positioning the wireless charging remote device over the transmitter coil of the wireless charger; and
activating the power converting circuit of the wireless charger and a power converting circuit of the wireless charging remote device to initiate power transfer; and
monitoring and adjusting the power transfer using the power converting circuit of the wireless charger and the power converting circuit of the wireless charging remote device.

20. The method according to claim 19, further comprises conducting periodic stress and thermal management analyses to ensure integrity of the mechanical support and effective heat dissipation.
